(19) United States
(12) Patent Application Publication
(10) Pub. No.: US 2012/0315778 A1
(43) Pub. Date: Dec. 13, 2012

(54) DEVICE FOR REMOVABLY FIXING A CONDUCTOR TO A CURRENT TRANSFORMER HOUSING

(75) Inventors: Christoph Leifer, Bad Driburg (DE); Carsten Thorner, Melle (DE); Dat-Minh Trinh, Barntrup (DE)

(73) Assignee: PHOENIX CONTACT GMBH & CO. KG, Blomberg (DE)

(21) Appl. No.: 13/516,476

(22) PCT Filed: Dec. 17, 2010
(86) PCT No.: PCT/EP2010/070164

§ 371 Date: Aug. 28, 2012

(30) Foreign Application Priority Data
Dec. 17, 2009 (DE) 10 2009 059 007.2

(51) Int. Cl. H01R 4/40

(52) U.S. Cl. 439/253

(57) ABSTRACT

The invention relates to a device for removably fixing a conductor (10) to a current transformer housing (12), comprising a fixing element (16) which runs through a retaining element (14) lying on the current transformer housing (12) and which at least partly sits against the surface of the conductor (10) when the conductor (10) is fixed on the current transformer housing (12). According to the invention, the fixing element (16) is designed such that when the conductor (10) is brought from an unfixed state and fixed on the current transformer housing (12), the fixing element (16) carries out a translational movement within the retaining element (14) along the longitudinal axis (54) of said fixing element in the direction of the conductor (10) and subsequently a rotational movement about the longitudinal axis (54) of said fixing element.

### FIELD

The innovation applies to a device for the detachable attachment of a conductor on a transformer housing with a fastening element, which is routed through a retaining element that is arranged on the transformer housing and that at least partially touches the surface of the conductor, when the conductor is fastened.

### BACKGROUND

A conductor is generally routed through an opening provided on the transformer housing. The conductor is generally secured on the transformer housing with two screws or threaded pins, which are inserted into two retaining elements arranged on the transformer housing. For fastening, the screws and/or threaded pins are turned inside of the retaining element with a purely rotating movement in the direction of the conductor until they touch the surface of the conductor with their sectional area. Further turning of the screws and/or threaded pins will secure the conductor on the transformer housing.

It is thereby disadvantageous that the screws and/or threaded pins must travel a relatively long path to secure it on the conductor, whereby this occurs with a purely rotating movement, which requires a great amount of force and time, especially with a larger number of transformer housings to be secured on a conductor.

The task of this innovation is therefore to provide a device for the detachable attachment of a conductor on a transformer housing, which is marked by a more simplified and faster installation.

### SUMMARY

The device for the detachable attachment of a conductor on a transformer housing according to the innovation has a fastening element, which is routed through a retaining element that is arranged on the transformer housing and that touches the surface of the conductor at least partially when the conductor is secured on the transformer housing. The innovation is marked in that the fastening element is designed so that the fastening element performs a translational movement in the direction of the conductor and then a rotating movement around its longitudinal axis along its longitudinal axis inside of the retaining element when transferring from an unfastened state to the fastened state of the conductor on the transformer housing.

The fastening element is preferably designed in form of an elongated pin-type element, which can be moved in the direction along its longitudinal axis for fastening of the conductor. To fasten the conductor, the fastening element can be moved in the direction of the conductor and to loosen the conductor, the fastening element can be moved away from the conductor, whereby the fastening element is preferably arranged for the conductor and/or routed to the conductor that the longitudinal axis of the fastening element is mainly arranged perpendicular to the longitudinal axis of the conductor. In the secured state, in which the conductor is secured on the transformer housing, the fastening element preferably touches the surface of the conductor with its cross section.

To fasten the conductor on the transformer housing, the fastening element is moved in the direction of the conductor, whereby the movement is first performed with a purely translational movement and the translational movement is followed by a rotating movement around the longitudinal axis of the fastening element, whereby a minor translational movement may occur in addition to the rotary movement. The greatest path of the fastening element is thereby preferably passed with the purely translational movement. The translator movement thereby preferably occurs within the retaining element, which means that the fastening element is routed through the retaining element during the translational movement. The rotating movement of the fastening element may occur not only inside of the retaining element but also outside of the retaining element. The retaining element is preferably designed in form of a flange, which is arranged on a side area of the transformer housing. The fastening element is thereby preferably routed through a through-hole inside of the retaining element.

As a result, the solution according to the innovation is marked in that no purely rotational movement of the fastening element is required anymore to fasten a conductor on a transformer housing, but the fastening element can first be moved with a purely translational movement in the direction of the conductor during which a rotation of the fastening element no longer occurs. This makes it possible to significantly reduce the effort when mounting the fastening element on the conductor and also the thereby required time so that the device according to the innovation provides a quick fastening of a conductor on the transformer housing. This quick fastening can thereby preferably occur without the necessity of an additional tool for fastening. To yield an even fastening, a retaining element and one moveable fastening element that is arranged in each one of them on two side areas of the transformer housing across from each other.

According to an advantageous design of the innovation the fastening element is designed so that the fastening element performs a rotational movement with an angle <360° around its longitudinal axis. Because a rotational movement around an angle of <360° occurs, the effort for the rotational movement of the fastening element is extremely minor. This makes it possible to further reduce the effort and time for the installation of such fastening element. The fastening element is thereby turned around its longitudinal axis once. This is preferably preferred without the necessity of an additional tool, such as a screwdriver.

It is further preferably provided that an internal thread is provided in some areas inside of the retaining element, within which an outside thread provided of the fastening element can engage at least in some areas. The fastening element is thereby preferably designed in form of a screw or threaded pin, whereby hereby preferably the outer thread provided on the fastening element is only provided in separate areas of the fastening element and does not extend across the entire outer surrounding surface of the fastening element. An inner thread is preferably provided in a through-hole provided within the retaining element and/or on the retaining element, through which the fastening element is routed, which is also only designed in certain areas in this through-hole, so that the entire through hole through which the fastening element is routed through the retaining element does not have an inside thread. Due to the fact that only a certain area of the retaining element and/or fastening element is designed with an inner thread and/or outer thread, the required rotary movement of the fastening element can be significantly reduced, which results in that the installation effort and installation time can be significantly reduced.

The inner thread is thereby preferably designed on a component that can additionally be inserted in the retaining element. The inner thread can therefore be replaced at any time so that the inner thread can be adjusted to the applicable fastening element that is used, for example, depending on the outer thread provided on the fastening element. The flexibility of the device according to the innovation can therefore be significantly increased because one retaining element can be used for different fastening elements, for example, and the complete retaining therefore does not have to be replaced when switching the type of fastening element.

The additional component must be arranged in the retaining element so that it can slide according to a preferred design of the innovation. For example, the additional component can thereby be provided in the retaining element so that the additional component and/or the inner thread of the additional component in the first position is not provided in the area of the through-hole in the retaining element so that the fastening element that is routed through the through-hole in the retaining element can perform a purely translational movement in the through-hole of the retaining element without obstruction and the additional component cannot be moved until the fastening element has traveled a certain distance inside of the retaining element so that the inner thread on the additional component can engage in the outer thread of the fastening element. As a result, the separation between the translational movement and rotating movement of the fastening element can be realized with significant efficiency.

It is preferably further provided that the retaining element has a first through-hole and a second through-hole to route the fastening element, whereby the first through-hole and second through-hole area arranged crosswise, whereby an inner thread is at least provided for some areas of the first through-hole. This may preferably include the provision that the fastening element is first fed through the second through-hole to fasten the conductor on the transformer housing, which does not have an inner thread and as soon as the fastening element touches the surface of the conductor, the fastening element can be moved from the second through-hole to the first through-hole, no that the outer thread of the fastening element can engage in the inner thread of the first through-hole and then be secured on the surface of the conductor with a subsequent translational movement of the fastening element. As a result, it is possible to specify exactly how far the fastening element will perform a purely translational movement, whereby the fastening is hereby routed purely translational until it touches the conductor and does not apply a rotational movement until it is finally secured on the surface of the conductor. This makes a further reduction of the installation time and installation effort possible.

According to another preferred design of the innovation, the retaining element can have a clamp-on latch element on the fastening element that is fed through the retaining element. For example, two or more spring arms may be attached on the retaining element, for which each end has a latch element. This latch element and/or latch elements may engage in the outer thread on the fastening element, for example, and thereby secure the fastening element inside of the spring arms and/or retaining element as soon as the fastening element is placed onto the conductor. Because the retaining element thereby preferably has spring arms that can be moved with elasticity up to a certain degree, the fastening element that is routed through the retaining element can be routed through the retaining element until it meets the surface of the conductor with its cross section and the latch elements do not engage until this time into the outer thread of the fastening element to secure it.

It is preferably thereby provided that a sleeve can be attached onto the retaining element. As soon as the fastening element is placed onto the surface of the conductor, the sleeve can be slid onto the retaining element, which consists of spring arms, so that the spring arms can be pressed against the outer surrounding area of the fastening element and especially because of that the latch elements on the spring arms can latch into the outer thread of the fastening element and secured on it by a force that is applies with the sleeve so that the fastening element can no longer be moved but is secured in this position.

According to another preferred design of the innovation, the retaining element has latch mechanisms on one of its outer side surfaces that can be used to adjust the distance between the retaining element and the conductor. This makes it possible to change the distance between the retaining element and the conductor so that a translational movement of the retaining element in the direction of the conductor is thereby be made possible. This provides the ability to further reduce the necessary rotational movement of the fastening element. The latch mechanisms that are provided on the outside surface of the retaining element can thereby preferably engage in a latch element on the transformer housing so that the retaining element is secured on the latch element as soon as the retaining element moves in the direction of the conductor far enough so that it is preferably placed onto the surface of the conductor. The conductor is thereby no only secured with the retaining element but also the fastening element that is fed through the retaining element.

Furthermore, another advantageous design of the innovation provides that the fastening element has a bayonet catch for a connection with the retaining element. Because of this, an especially short twist movement and/or rotational movement of the fastening element is required to secure a conductor on a transformer housing.

The innovation is explained in more detail with reference to the figures below.

### BRIEF DESCRIPTION OF THE DRAWINGS

The following is shown:

FIG. 1 a device according to the innovation to fasten a conductor on a transformer housing according to an initial design;

FIG. 2 a second schematic illustration of the device according to the innovation shown in FIG. 1 in unsecured state;

FIG. 3 a third schematic illustration of the device according to the innovation shown in FIG. 1, where a fastening element is inserted into a retaining element;

FIG. 4 a fourth schematic illustration of the device according to the innovation shown in FIG. 1, where the fastening element shown in FIG. 3 is arranged in the retaining element;

FIG. 5 a fifth schematic illustration of the device according to the innovation shown in FIG. 1, where a sleeve is slid onto the retaining element;

FIG. 6 a schematic cross section illustration of the device according to the innovation shown in FIG. 1;

FIG. 7 a first schematic illustration of a device according to the innovation according to a second design;

FIG. 8 a second schematic illustration of the device according to the innovation shown in FIG. 7 with a cross section illustration of the retaining element without a fastening element arranged therein;

FIG. 9 a schematic cross section illustration of the device according to the innovation shown in FIG. 7 where a fastening element is inserted into the retaining element;

FIG. 10 a schematic cross section illustration of the device according to the innovation shown in FIG. 7 in a secured state of the conductor on the transformer housing;

FIG. 11a a first schematic illustration of a device according to the innovation according to a third design;

FIG. 11b a second schematic illustration of a device according to the innovation according to a third design;

FIG. 12 a schematic illustration of a device according to the innovation according to a fourth design;

FIG. 13 a schematic top view of a device according to the innovation shown in FIG. 12 without any arranged fastening elements therein;

FIG. 14 a schematic illustration of a device according to the innovation according to a fifth design;

FIG. 15 a schematic cross section illustration of the retaining element of the device according to the innovation shown in FIG. 14 without a fastening element arranged therein;

FIG. 16 another schematic cross section illustration of the retaining element shown in FIG. 15 with an arranged fastening element therein;

FIG. 17 a schematic illustration of a device according to the innovation according to a sixth design, whereby the device is partially shown in cross sections;

FIG. 18 an exploded illustration of the device according to the innovation shown in FIG. 17.

### DETAILED DESCRIPTION

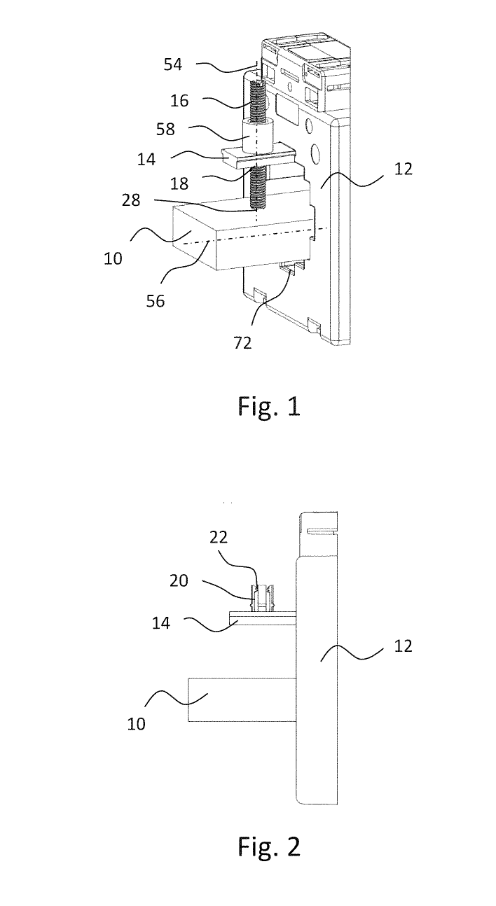

FIG. 1 shows a first device according to the innovation according to its first design, where a conductor 10 is attached on a transformer housing 12, whereby the conductor 10 is routed through a through-hole 72 provided on the transformer housing 12. For this purpose, a retaining element 14 and a second retaining element that is not shown here is designed on the transformer housing 12, which protrude from the transformer housing and are designed in form of a flange, whereby one fastening element 16 each, which secures the conductor 10 on the transformer housing 12, is routed through the retaining element 14. The retaining element 14 can be designed as a single part and also with multiple parts. The retaining element 14 has a through-hole 18 for this purpose, through which the fastening element 16 is routed. The fastening element 16 is hereby designed in form of a threaded pin, whereby the fastening element 16 is designed with its longitudinal axis 54 perpendicular to the longitudinal axis 56 of the conductor 10. When it is secured as it is shown here in FIG. 1, the open end 28 of the fastening element 16 is placed onto the surface of the conductor 10 with its cross-sectional surface.

FIG. 2-6 show more detailed illustrations of the device according to the innovation according to the first design as shown in FIG. 1.

FIG. 2 shows the retaining element 14 with four integrated circular arranged spring arms 20, for which one latch element 22 is designed on the open end of the spring arms 20, whereby the latch elements are shaped thread-like to be able to secure the fastening element 16 on the surface of the conductor 10 with a rotational movement of the fastening element 16 preferably with an angle of <360°. The fastening element 16 can thereby be routed through the retaining element 14 first with a purely translational movement in the direction of the conductor 10 before it finishes the attachment by performing a rotational movement with an angle of <360°.

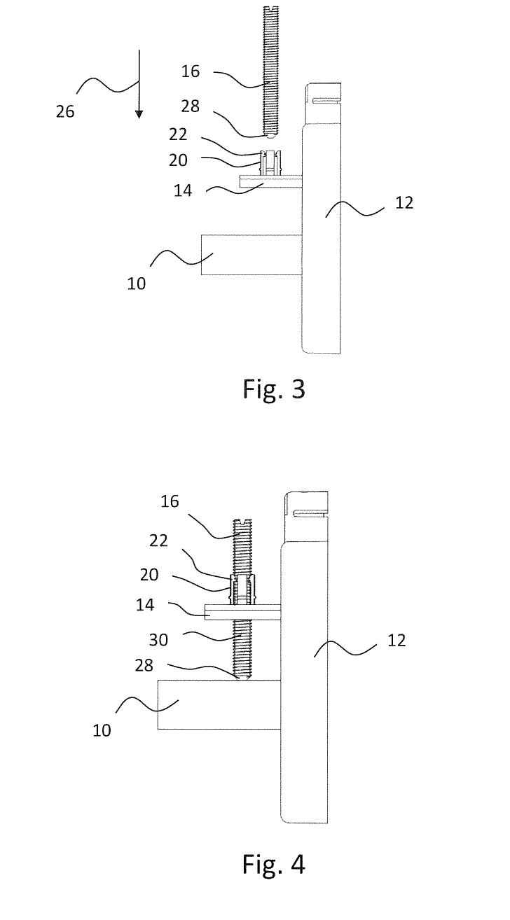

FIG. 3 shows an illustration where the fastening element 16 is shown while being moved in the direction of the retaining element 14, which is illustrated with arrow 26. When the fastening element 16 is inserted into the retaining element 14, the spring arms 20 of the retaining element 14 are pressed apart so that the fastening element 16 can be routed through the retaining element 14 far enough with a purely translational movement until its open end 28 is placed onto the surface of the conductor 10 as shown in FIG. 4.

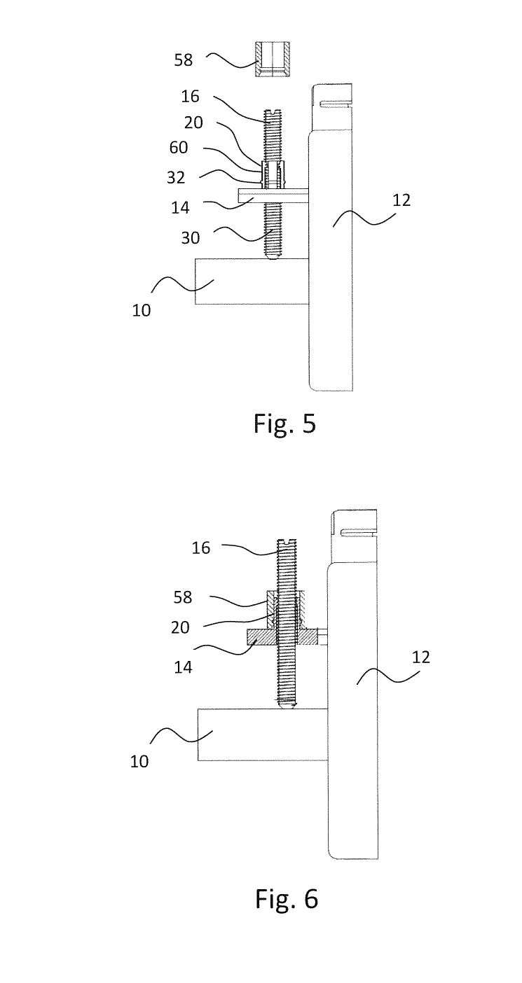

FIG. 4 also shows that the latch elements 22 provided on the spring arms 20 engage in the outer thread 30 of the fastening element 16 in this state. In order for the spring arms 20 to be able to secure the fastening element 16, a sleeve 58 is slid onto the retaining element 14 and/or the spring arms 20 of the retaining element 14 as shown in FIG. 5, which can engage in snap tabs 32 arranged on the outside 60 of the spring arms 20 of the retaining element. The sleeve 58 is used to press the spring arms 20 and latch elements 22 of the spring arms 20 toward the outer thread 30 of the fastening element 16 so that the latch elements 22 can engage in the outer thread 30 and thereby secure the fastening element 16 in this position.

FIG. 6 shows a cross section where the sleeve 58 is slid onto the spring arms 20 of the retaining element 14. To reach a final attachment of the fastening element 16 on the conductor 10, the fastening element 16 is moved with a rotational movement in the latch elements 22 of the retaining element 14, whereby a rotational movement of the fastening element 16 occurs preferably with an angle of <360°. The rotational movement of the fastening element 16 hereby only serves to finish the attachment of the conductor 10. Prior to that, an almost purely translational movement of the fastening element 16 will occur.

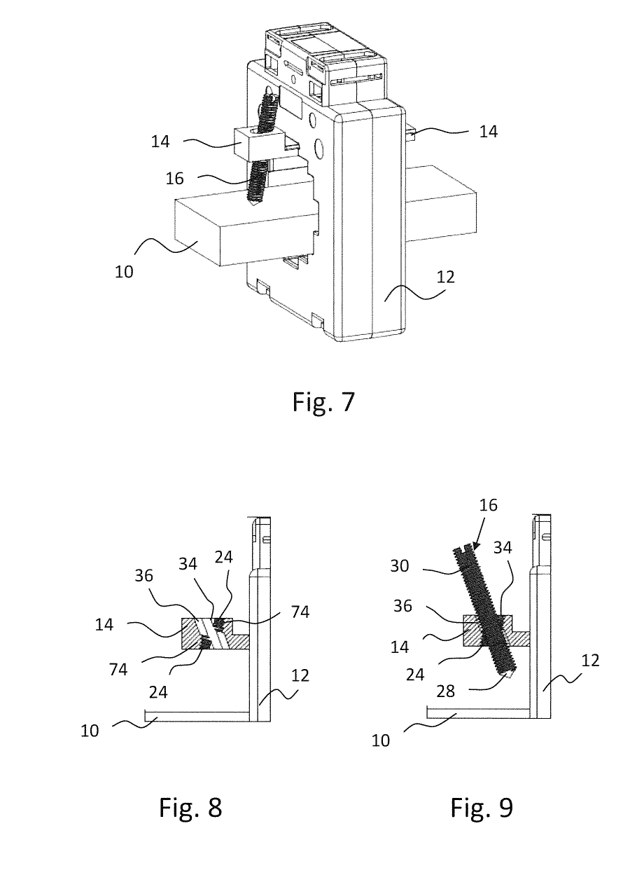

FIG. 7-10 show a device according to the innovation according to a second design, where a fastening element 16 is routed through a fastening element 14 in form of threaded pin to fasten the conductor 10 on the transformer housing 12.

As shown in the cross section illustration of the retaining element 14 as shown in FIG. 8, the retaining element 14 has a first through-hole 34 and a second through-hole 36, whereby the first through-hole 34 and the second through-hole 36 are arranged crossing each other, preferably with an angle between 15° and 20° offset to each other. The first through-hole 34 thereby has an inner thread 24, which is preferably designed only on one side surface 74 of the first through-hole, whereby this side surface 74 switches through the second through-hole 36 after transferring the first through-hole.

To attach or secure the conductor 10 the fastening element 16 is first routed through the second through-hole 36 with a purely translational movement as shown in FIG. 9 until its open end 28 is placed onto the surface of the conductor 10. As soon as the fastening element 16 touches the surface of the conductor 10, the fastening element 16 is swiveled from the second through-hole 36 to the first through-hole 34 in the retaining element 14, so that the outer thread 30 of the fastening element 16 can engage in the inner thread 24 of the first through-hole 34. A rotational movement of the fastening element 16 now allows the fastening element 16 to secure the conductor 10 on the transformer housing 12, whereby only a short twist of the fastening element 16 is hereby required, preferably with an angle of <360°.

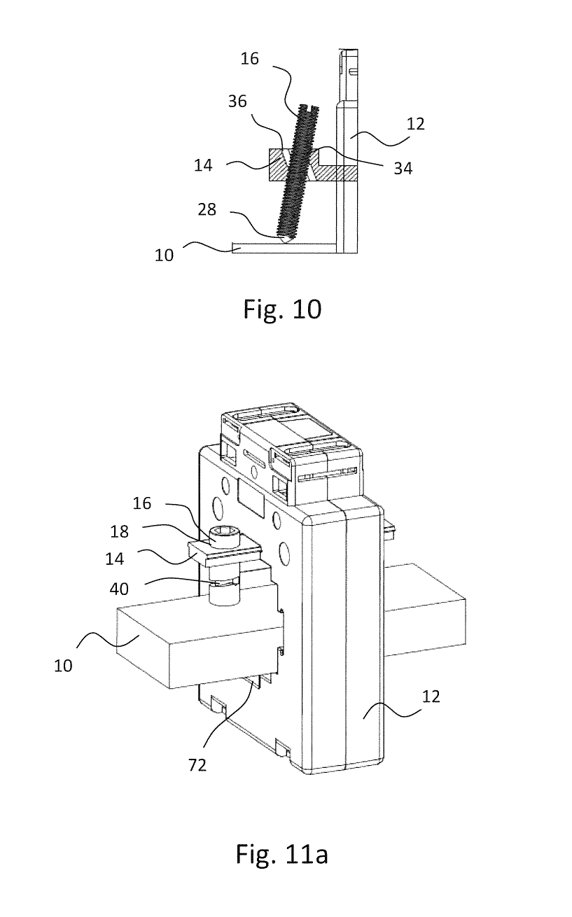

This final position is shown in FIG. 10. The swivel movement of the fastening element 16 thereby preferably occurs with an angle of approximately 15° from the first through-hole 34 to the second through-hole 36.

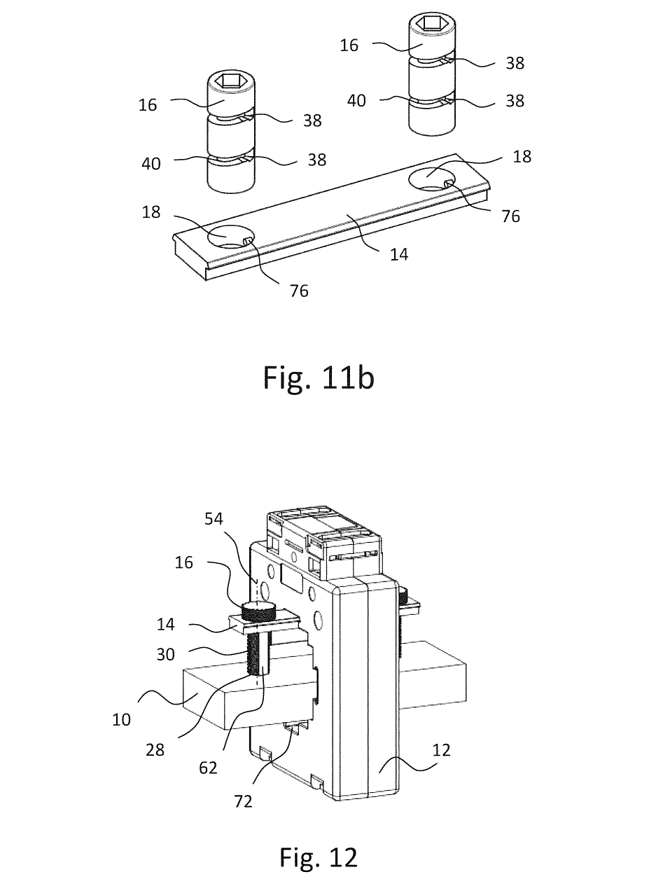

FIG. 11a and 11b show a device according to the innovation according to a third design, whereby the fastening element 16 is hereby connected to the retaining element 14 in form of a bayonet catch. For this purpose, the fastening element 16 is hereby routed through a through-hole 18 of the retaining element 14 with a purely translational movement. A pin 76 is provided in the through-hole 18, which is guided along a thread-type guide 40 on the fastening element 16 before it can latch with a rotational movement of the fastening element 16 in a groove 38 within the thread-type guide 40 to affect a final securing of the fastening element 16 on the surface of the bus bar 10. Preferably, more than one bayonet catch are hereby provided for each fastening element 16.

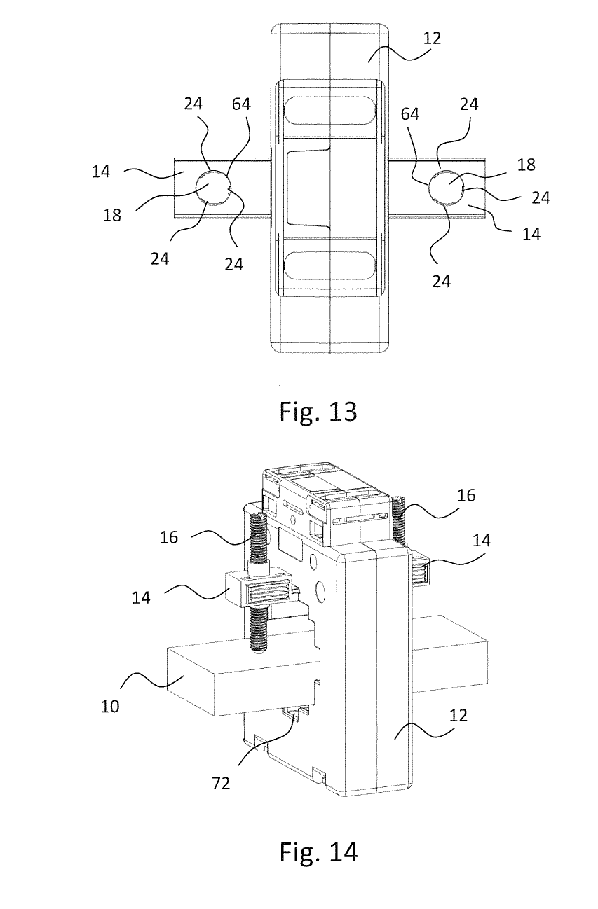

FIGS. 12 and 13 show another device according to the innovation according to a fourth design, whereby the fastening element 16 is hereby designed in form of a screw, whereby the fastening element 16 has an outer thread 30, which is only provided in a certain area on the fastening element 16. The outer thread 30 is hereby interrupted by one or more areas 62, whereby these areas 62 extend across the entire length of the fastening element 16. The outer thread or threads 30 are therefore preferably only designed around the longitudinal axis 54 of the fastening element 16 with an angle from 20° to 180°, preferably 45°-90°.

FIG. 13 shows a top view onto the device shown in FIG. 12 without an internally arranged fastening element 16, whereby the retaining element 14 can hereby be recognized, which has a through-hole 18 to insert the fastening element 16, whereby the through-hole 18 has an inner thread 24, which is only provided in areas within the through-hole 18. Three sections of an inner thread 24 are hereby provided, whereby these three sections extend by preferably only an angle of 20°-180° each, preferably 45°-90° around the inner circumference 64 of the through-hole 18. When the fastening element 16 is routed through the retaining element 14, a fastening element 16 is thereby inserted into the retaining element 14 that the area 62 shown in FIG. 12, which does not have an outer thread 30, is routed along the inner circumference 64 of the through-hole 18 of the retaining element 14, where the inner thread 24 is provided. The outer thread 30 of the fastening element 16 is not screwed into the inner thread 24 of the retaining element until the open end 28 of the fastening element 16 is placed onto the conductor 10, so that the fastening element 16 only has to travel a rotational movement or twist movement with an angle of preferably 360° to achieve a final securing of the conductor 10 on the transformer housing 12.

FIG. 14-17 show a device according to the innovation according to a fifth design, where a fastening element 16 designed in form of a threaded pin is routed through a retaining element 14.

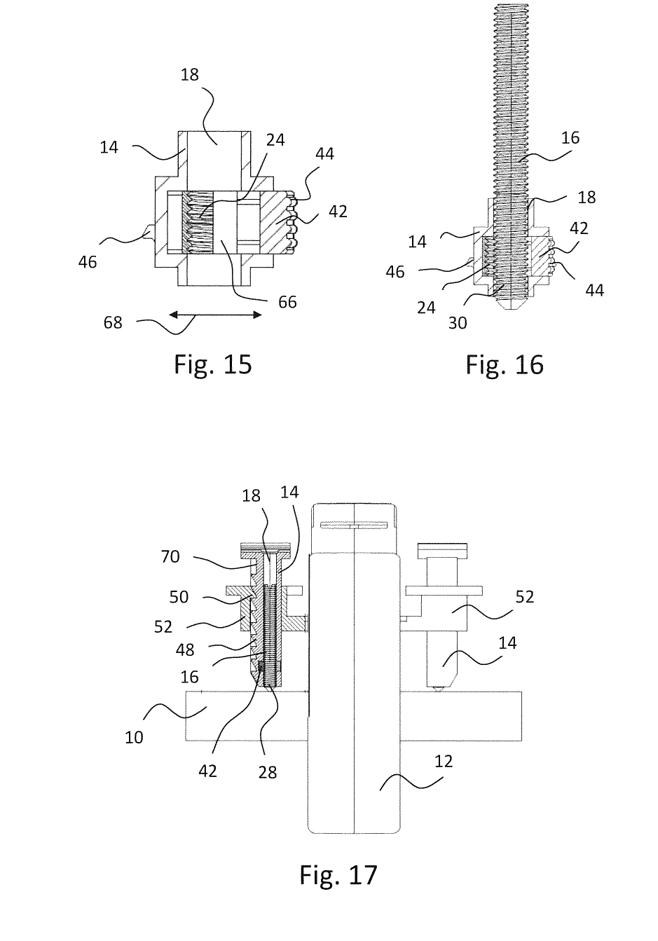

As can be recognized in FIG. 15, the retaining element 14 has a through-hole 18, whereby an additional component 42 is inserted in the area of the through-hole 18 on the retaining element 14, which also has a through-opening 66 and an inner thread 24 that is at least partially arranged inside of it. The additional component 42 is thereby arranged so that it can be moved by sliding inside of the retaining element 14 along the arrow 68. The additional component 42 can thereby be operated and/or moved with an operating surface 44 that is provided outside of the retaining element 14. FIG. 15 shows the retaining element 14 so that no fastening element 16 has been routed through.

FIG. 16 shows the retaining element 14, whereby a fastening element 16 is routed through the through-hole 18 of the retaining element 14. To insert the fastening element 16, the additional component 42 is thereby moved to the left as shown here so that the fastening element 16 can freely be routed through the through-hole 18 of retaining element 4 and through-hole 66 of the additional component 42 without the fastening element 16 engaging in the inner thread 24 of the additional component 42, until the open end 28 of the fastening element is placed on the surface of the conductor 10. As soon as the fastening element 16 is placed onto the conductor 10, the additional component 42 will be moved to the right until the inner thread 24 of the additional component 42 can secure the fastening element 16 in its position. The additional component 42 is preferably designed with a spring, not shown here, so that the additional component 42 can be moved back and forth with the operating surface 44 under a pre-tension load. To release the fastening element 16, the additional component 42 can be moved back to the left from the secured state shown in FIG. 16 and the inner thread 14 can therefore be disengaged from the outer thread 30 and the fastening element 16 can therefore be routed out of the through-hole 18 of the retaining element 14 again.

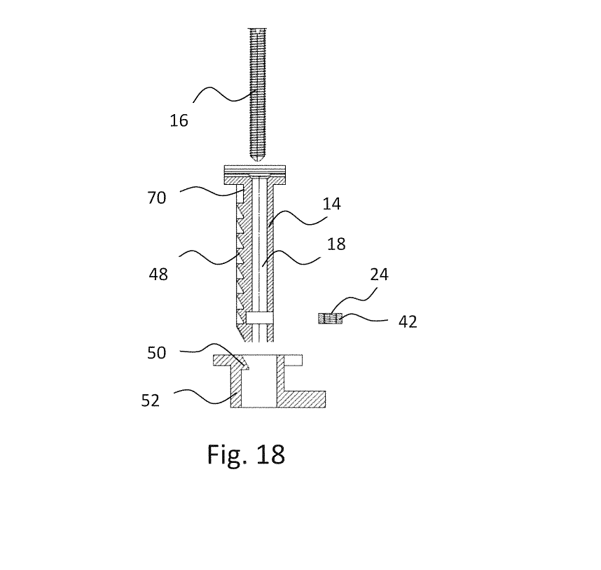

FIGS. 17 and 18 show a device according to the innovation according to a sixth design, whereby the fastening element 16 is hereby routed through a through-hole 18 provided on the retaining element 14 in form of a threaded pin, whereby the retaining element 14 has a latch mechanism 48 on its outer side surface 70. The fastening element 16 is hereby preferably already pre-installed in the retaining element 14. The retaining element 14 is thereby designed, so that it can perform a translational movement in the direction of the conductor 10 and from the conductor 10 away so that the distance between the retaining element 14 and conductor 10 can be adjusted. For this purpose, the latch mechanisms 48 engage in a latch element 50 of a mounting element 52, whereby the mounting element 52 is arranged directly on the transformer housing 12. To fasten the conductor 10 with this design, the retaining element 14 is first moved with its latch mechanism 48 in the direction of the conductor 10 until the retaining element 14 preferably rests on the surface of the conductor 10. As soon as the retaining element 14 rests on the conductor 10, the fastening element 16 will first be routed in the direction of the conductor 10 with a translational movement in the retaining element 14 until the fastening element 16 engages in an additional component 42 with an inner thread 24 provided in the retaining element 14. The additional component 42 can be designed separately or as a fixed component of the retaining element 14, preferably in a single piece with the retaining element 14. A rotational movement of the fastening element 16 in the direction of the conductor 10 by engaging of the outer thread 30 of the fastening element 16 in the inner thread 24 of the additional component 42, the conductor 10 will also be secured in addition to retaining element 14 with fastening element 16, which rests with its open end 28 on the surface of the conductor 10.

FIG. 18 shows the design shown in FIG. 17 in its exploded view, whereby the individual elements are hereby shown individually and it can be recognized that the inner thread 24 is preferably designed in an additional component 42, which is additionally inserted in retaining element 14.

### REFERENCE CODE LIST

Conductor 10
Transformer housing 12
Retaining element 14
Fastening element 16
Through-hole 18
Spring arm 20
Latch element 22
Inner thread 24
Arrow 26
Open end 28
Outer thread 30
Latch tab 32
First through-hole 34
Second through-hole 36
Grooving 38
Thread-type guide 40
Additional component 42
Operating surface 44
Operating element 46
Latch device 48
Latch element 50
Mounting element 52
Longitudinal axis 54
Longitudinal axis 56
Sleeve 58
Outer side 60
Area 62
Inner circumference 64
Through-area 66
Arrow 68
Outside area 70
Through-hole 72
Side area 74
Pin 76

What is claimed is:

1. A device for the detachable attachment of a conductor (10) on a transformer housing (12), comprising the transformer housing (12) and a fastening element (16), whereby
the fastening element (16) is routed through a retaining element (14) that is arranged on the transformer housing (12) and that rests at least partially on the surface of the conductor (10) when the conductor is (10) secured on the transformer housing (12), and
the fastening element (16) is designed so that the fastening element (16), when transferring from an unattached state to the fastened state of the conductor (10) on the transformer housing (12) within the retaining element (14) along its longitudinal axis (54), performs a translational movement in the direction of the conductor (10) and then a rotating movement around its longitudinal axis (54).

2. A device according to claim 1, marked in that the fastening element (16) is designed so that the fastening element (16) performs a twisting movement with an angle of <360° around its longitudinal axis (54) during the rotational movement.

3. A device according to claim 1, wherein in that an inner thread (24) is provided inside of the retaining element (14), inside of which an outer thread (30) provided on the fastening element (16) can engage at least in a partial area.

4. A device according to claim 3, wherein the inner thread (24) is designed on a component (42) that can additionally be inserted into the retaining element (14).

5. A device according to claim 4, wherein the additional component (42) can be arranged in the retaining element (14) slidable.

6. A device according to claim 3, wherein the retaining element (14) has a first through-hole (34) and a second through-hole (36) to feed the fastening element (16) through, whereby the first through-hole (34) and the second through-hole (36) are arranged crossing each other, whereby the inner thread (24) is designed in the first through-hole (34) at least partially.

7. A device according to claim 1, wherein the retaining element (14) has a clampable latch element (22) that can be clamped unto the fastening element (16) that is routed through the retaining element (14).

8. A device according to claim 1, wherein a sleeve (58) can be slid onto the retaining element (14).

9. A device according to claim 1, wherein the retaining element (14) has latching mechanisms (48) on one of its outer side surfaces (70) that can be used to adjust the distance between the retaining element (14) and the conductor (10).

10. A device according to claim 1, wherein the fastening element (16) has a bayonet catch for connection with the retaining element.
